(19) United States
(12) Patent Application Publication
(10) Pub. No.: US 2015/0379586 A1
(43) Pub. Date: Dec. 31, 2015

(54) UTILIZING SOCIAL MEDIA DATA FOR DIGITAL COMMUNICATION

(71) Applicant: The Social Gaming Company, Milltimber (GB)

(72) Inventors: Sion Mooney, Auchterarder (GB); Oliver Southgate, Poole (GB); Craig Hepburn, Horley (GB)

(21) Appl. No.: 14/318,818

(22) Filed: Jun. 30, 2014

(51) Int. Cl. G06Q 30/02

(52) U.S. Cl. CPC G06Q 30/0277; G06Q 30/0282

(57) ABSTRACT

A method and system for increasing an appeal of product offers with user-generated content items is provided. The method and system includes defining attributes of the product offers, collecting the user-generated content items having attributes matching the defined product offer attributes at a content resources storage device, ranking the matching user-generated content items for relevance to the product offers, combining a first set of highly ranked user-generated content items with a first product offer and replacing the first set of highly ranked user-generated content items with a second set of highly ranked user-generated content items when the second set of highly ranked user-generated content items is determined to have a relevance ranking to the first product offer which is higher than a relevance ranking of the first set of highly ranked user-generated content items.

### TECHNICAL FIELD

The present disclosure relates to the field of online advertisements and, in particular, relates to the field of utilizing user generated content from various social media websites and for digital communications which include online advertisements, online promotions, online sponsorships and the like.

### BACKGROUND

In this competitive world, businesses want to increase sale of their products and spend vast amounts of money in advertisements and brand promotions. Build a relationship with consumers by utilizing social media platforms is a frequently used marketing strategy. Businesses also attempt to influence consumers by fetching recommendations from their peers, experts, influencers and the like on the social media platforms.

Unlike a traditional marketing scenario in which a link between a consumer and a producer starts with an advertisement of a product and ends at a point of sale, in today's marketing scenario, the relationship between the consumer and the producer (a producer of a brand or a company) extends into the period after product purchase. After purchasing a product, consumers often share their experiences online on social media platforms to promote or assail products they have purchased. After reading positive reviews and experiences on social media platforms, other consumers may also be encouraged to to purchase the same product from the producer.

### SUMMARY

In one aspect, the present disclosure concerns a computer-implemented method for increasing appeal of product offers with user-generated content. The computer-implemented method includes the actions of:

defining attributes of the product offers,

collecting, at a content resources storage device, user-generated content items having attributes matching the defined product offer attributes,

ranking the matching user-generated content items for relevance to the product offers,

combining a first set of highly ranked user-generated content items with a first product offer, and

replacing the first set of highly ranked user-generated content items with a second set of highly ranked user-generated content items when the second set of highly ranked user-generated content items is determined to have a higher relevance ranking to the first product offer than a relevance ranking of the first set of highly ranked user-generated content items.

Ranking the user-generated content items may further include amplifying the rank of the user generated content items with a heuristics value for a level of compliment the user-generated content items assign to the product offers or products advertised thereby, weighing the rank of the user-generated content items with an influential power of social accounts from which the user-generated content items are collected and/or scaling the rank of the user-generated content items by a number of defined product attributes with which the user-generated content item is matched.

The computer-implemented method may further include defining a threshold of publishability for the product offers (hereinafter referred to as “publishability threshold’), publishing the combined first set of highly ranked user-generated content items and first product offer when a ranking of the first set of highly ranked user-generated content items exceeds the threshold of publishability for the first product offer, and forgoing publication of the combined first set of highly ranked user-generated content items and first product offer when the publishability threshold for the first product offer exceeds the ranking of the first set of highly ranked user-generated content item. The first set of highly ranked user-generated content items includes one or more highly ranked user-generated content items.

The computer-implemented method may further include continuously updating the content resources storage device by collecting newly published user-generated content items from the social media websites and removing user-generated content items which have expired due to unacceptable age or low ranking.

Combining the first set of highly ranked user-generated content items with the first product offer may further include constructing a webpage widget from the first set of highly ranked user-generated content items.

The computer-implemented method may further include scoring the ranked user-generated content items for popularity, and replacing the first product offer with a second product offer when a popularity score of a third set of highly ranked user-generated content items combined with the second product offer exceeds a popularity score of the first set of highly ranked user-generated content item.

Scoring the ranked user-generated content items for popularity may further include counting a number of interactions experienced by the product offers combined therewith.

In another aspect, the present disclosure addresses a computer program product to increase appeal of product offers with user-generated content. The computer program product resides on a non-transitory computer readable storage medium and comprises instructions that, when executed by a processor, cause one or more computers to:

define attributes of the product offers,

collect, at a content resources storage device, user-generated content items having attributes matching the defined product offer attributes,

rank the matching user-generated content items for relevance to the product offers,

combine a first set of highly ranked user-generated content items with a first product offer, and

replace the first set of highly ranked user-generated content items with a second set of highly ranked user-generated content items when the second set of highly ranked user-generated content items is determined to have a relevance ranking to the first product offer which is higher than a relevance ranking of the first set of highly ranked user-generated content items.

The instructions causing the one or more computers to rank the user-generated content may further cause the one or more computers to amplify the rank of the user generated content items with a heuristics value for a level of compliment the user-generated content items assign to the product offers or products advertised thereby, weigh the rank of the user-generated content items with an influential power of social accounts from which the user-generated content items are collected, and/or scale the rank of the user-generated content items by a number of defined product attributes with which the user-generated content item is matched.

The computer program product may further include instructions that, when executed by the processor, cause one or more computers to define a threshold of publishability for the product offers, publish the combined first set of highly ranked user-generated content items and first product offer when a ranking of the first set of highly ranked user-generated content items exceeds the threshold of publishability for the first product offer, and forgo publication of the combined first set of highly ranked user-generated content items and first product offer when the threshold of publishability for the first product offer exceeds the ranking of the first set of highly ranked user-generated content items.

The computer program product may further include instructions that, when executed by the processor, cause the one or more computers to continuously update the content resources storage device by collecting newly published user-generated content items from the social media websites and removing user-generated content items which have expired due to unacceptable age or low ranking.

The instructions that cause the one or more computers to combine the first set of highly ranked user-generated content items with the first product offer may further include instructions causing the one or more computers to construct a webpage widget from the first set of highly ranked user-generated content items.

The computer program product may further include instructions that, when executed by the processor, cause the one or more computers to score the ranked user-generated content items for popularity, and replace the first product offer with a second product offer when a popularity score of a third set of highly ranked user-generated content items combined with the second product offer exceeds a popularity score of the first set of highly ranked user-generated content items.

The instructions that cause the one or more computers to score the user-generated content items for popularity may further include instructions causing the one or more computers to count a number of interactions experienced by the product offers combined therewith.

In yet another aspect, the present disclosure concerns a system for increasing an appeal of product offers with user-generated content items. The system includes a memory, a content resources storage device, and a library, stored in the memory, defining attributes of the product offers (hereinafter product offer attributes) as well as a plurality of utilities. The utilities include a content-crawler, a ranking engine, and a presentation manager. The content-crawler is arranged to collect, at the content resources storage device, user-generated content items having attributes matching the attributes of the product as defined by the library. The ranking engine is configured to rank the matching user-generated content items for relevance to the product offers. The presentation manager is arranged to combine a first set of highly ranked user-generated content items with a first product offer and replace the first set of highly ranked user-generated content items with a second set of highly ranked user-generated content items when the second set of highly ranked user-generated content items is determined to have a relevance ranking to the first product offer which is higher than a relevance ranking of the first set of highly ranked user-generated content items. The system further includes a processor configured to activate the utilities.

The ranking engine may be further configured to amplify the rank of the user generated content items with a heuristics value for a level of compliment the user-generated content items assign to the product offers or products advertised thereby, weigh the rank of the user-generated content items with an influential power of social accounts from which user-generated content items are collected and/or scale the rank of the user-generated content items by a number of defined product offer attributes with which the user-generated content item is matched.

The system may further include a filter defining a threshold of publishability for the product offers. The presentation manager may be further arranged to publish the combined first set of highly ranked user-generated content items and first product offer when a ranking of the first set of highly ranked user-generated content items exceeds the threshold of publishability for the first product offer, and forgo publication of the combined first set of highly ranked user-generated content items and first product offer when the publishability threshold for the first product offer exceeds the ranking of the first set of highly ranked user-generated content items.

The content crawler may be further arranged to continuously update the content resources storage device by collecting newly published user-generated content items from the social media websites and removing user-generated content items which have expired due to unacceptable age or low ranking.

The presentation manager may be further arranged to construct a webpage widget from the first set of highly ranked user-generated content items in order to combine the first set of highly ranked user-generated content items with the first product offer.

The plurality of utilities may further include a scoring engine configured to score the ranked user-generated content items for popularity. The presentation manager may be further configured to replace the first product offer with a second product offer when a popularity score of a third set of highly ranked user-generated content items combined with the second product offer exceeds a popularity score of the first set of highly ranked user-generated content items.

The scoring engine may be further configured to count a number of interactions experienced by the user-generated content items or the product offers combined therewith in order to score the user-generated content items for popularity.

### BRIEF DESCRIPTION OF THE FIGURES

FIG. 1 illustrates a system for increasing appeal of product offers with user-generated content, in accordance with the present disclosure;

FIG. 2 illustrates a block diagram of a social advertisement group platform for increasing appeal of the product offers, in accordance with the present disclosure;

FIG. 3 illustrates a flowchart for increasing appeal of the product offers with the user-generated content, in accordance with the present disclosure; and

FIG. 4 illustrates a flowchart for ranking the user-generated content, in accordance with the present disclosure.

FIG. 5 illustrates an example communication device 502 for providing a digital communication service utilizing social media.

### DETAILED DESCRIPTION

Various attempts have been made to leverage experiences of consumers published on social media and various methods and systems have been devised to utilize data related to posts and comments by users on the social media platforms to enhance overall sales of products; particularly online sales. Presently, social media objects (e.g. comments, tweets and the like) are collected from social media platforms. These social media objects are analyzed and re-published to third party websites. Ranking systems calculate relevancy of each social media object. The social media objects may then be dynamically linked to advertisements of the product.

Existing methods and systems do not enable dynamic adaptation of advertisements of a product to republished social media objects. Further, the existing methods and systems do not enable association of the social media objects to the advertisements of the product the social media objects address. For at least these reasons, existing methods and systems fail to generate views of advertiser web pages that could otherwise be generated.

There is a need for a method and system which overcomes shortcomings of the prior art and which, in part, enables dynamic adaptation of advertisements to republished social media objects and enables association of social media objects to advertisements of the products they reference.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

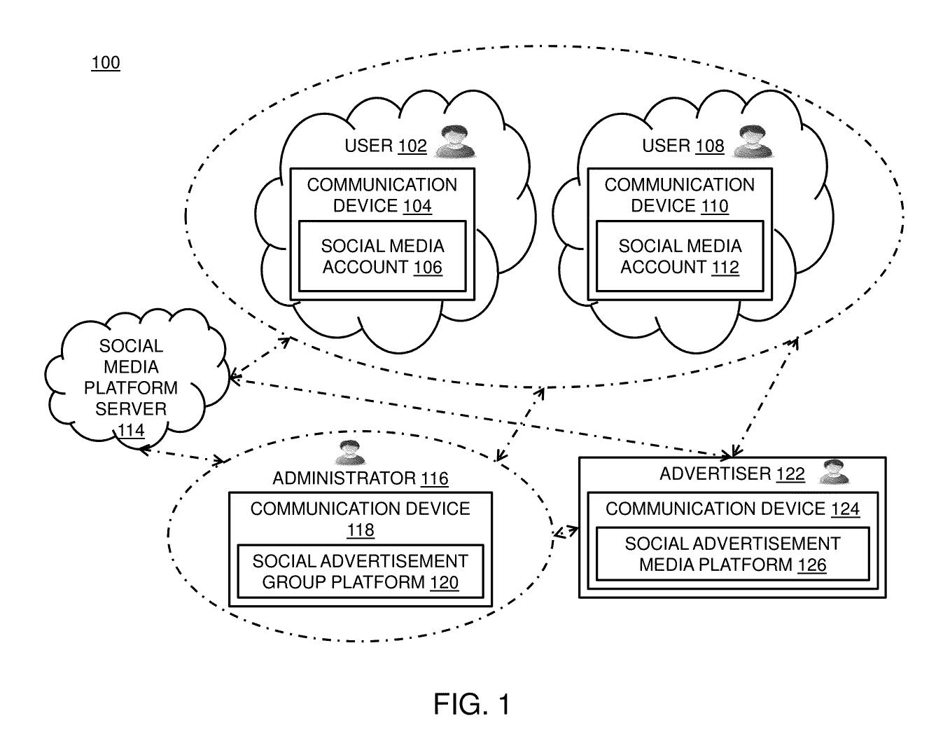

FIG. 1 illustrates interaction among various components of a system 100 for increasing an appeal of product offers with user-generated content items, in accordance with an embodiment of the present disclosure. System 100 includes a communication device 104 associated with a user 102, a communication device 110 associated with a user 108, a social media platform server 114, a communication device 118 associated with an administrator 116 and a communication device 124 associated with an advertiser 122. User 102 may access a social media account 106 by using communication device 104. Similarly, user 108 may access a social media account 112 by using communication device 110. Administrator 116 may access a social advertisement group platform 120 by using communication device 118. Advertiser 122 may access a social advertisement media platform 126 by using communication device 124.

In an embodiment, social advertisement group platform 120 may also include a system for obtaining permission from user 102 and user 108 to store and display user-generated content and/or user-generated content items of user 102 and user 108 from social media account 106 and social media account 112.

Social media platform server 114 maintains the user-generated content and/or user-generated content items of each of user 102 and user 108. The user-generated content items may include one or more of: posts, comments, likes, tweets, images video on social media platforms, but are not limited thereto. In an embodiment of the present disclosure, advertiser 122 utilizes the user-generated content items for increasing an appeal of product offers. Advertiser 122 advertises product offers on social advertisement media platform 126 by using communication device 124 and interacts with social advertisement group platform 120 to access the user-generated content items. Social advertisement group platform 120 interacts with social media platform server 114 to collect the user-generated content items of user 102 and user 108.

It may be noted that FIG. 1 is shown to have two users using the social media accounts, user 102 and user 108, having social media account 106 and social media account 112, respectively; however, those skilled in the art would appreciate that multiple users can use the social media accounts to post statuses, comments, reviews and the like. Moreover, more than one advertiser may interact with social advertisement group platform 120 to collect user-generated content items of multiple users for their different product offers.

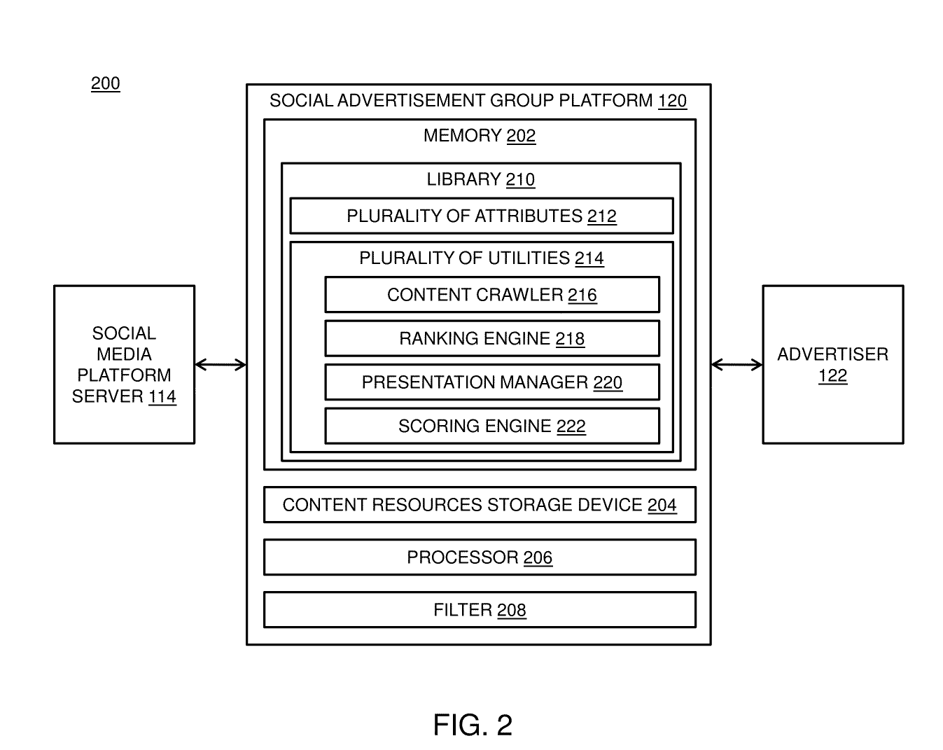

FIG. 2 illustrates a block diagram 200 of social advertisement group platform 120, in accordance with an embodiment of the present disclosure. Social advertisement group platform 120 includes a memory 202, a content resources storage device 204, a processor 206 and a filter 208. Memory 202 further includes a library 210.

Library 210 comprises a plurality of attributes 212 and a plurality of utilities 214. Attributes 212 define attributes of the product offers that including but not be limited to a brand name, a product name and characteristics of the product offers. Utilities 214 include a content crawler 216, a ranking engine 218, a presentation manager 220 and a scoring engine 222.

Content crawler 216 collects the user-generated content items, having attributes similar to attributes 212, namely attributes of the product offers defined by library 210, in content resources storage device 204. In an example, a product offer ‘X’ has a plurality of attributes ‘a’, ‘b’ and ‘c’ and a user ‘U’ posts a comment (user-generated content item) on his/her social media account. If the comment includes one or more attributes matching attributes 212, then content crawler 216 stores the comment in content resources storage device 204.

Further, ranking engine 218 ranks or prioritizes matching user-generated content items according to relevance to the product offers. For example, if various users post comments for the product offer ‘X’, then ranking engine 218 analyzes the comments and ranks the comments in terms of their relevancy to the product.

In an embodiment of the present disclosure, ranking engine 218 determines ranks of the regularly updated user-generated content items at different instances. Presentation manager 220 combines a first set of highly ranked user-generated content items, for example at a first instance of time, with a first product offer and replaces the first set of highly ranked user-generated content items with a second set of highly ranked user-generated content items, for example at a second instance of time when the second set of highly ranked user-generated content items is determined to have higher relevance ranking than relevance ranking of the first set of highly ranked user-generated content items. Thus, the user-generated content items associated with the product offer are dynamically updated according to relevance ranking.

Furthermore, processor 206 in social advertisement group platform 120 activates utilities 214 and configures other components of social advertisement group platform 120.

Filter 208 defines a threshold of publishability for the product offers. Filter 208 works with presentation manager 220 to either publish the combined first set of highly ranked user-generated content items and the first product offer or to forgo publication of the combined first set of highly ranked user-generated content items and the first product offer. If a ranking of the first set of highly ranked user-generated content items exceeds the threshold of publishability for the first product offer, presentation manager 220 publishes the combined first set of highly ranked user-generated content items and the first product offer. If the threshold of publishability for the first product offer exceeds the ranking of the first set of highly ranked user-generated content items, presentation manager 220 forgoes publication of the combined first set of highly ranked user-generated content items and the first product offer.

In another embodiment of the present disclosure, ranking engine 218 performs one or more functions including amplifying the rank of the user-generated content items, weighing the rank of the user-generated content items and scaling the rank of the user-generated content items. The ranking engine 218 amplifies the rank of the user-generated content items with a heuristic value for a level of compliment the user-generated content items assign to the product offers/products advertised. For example, words, such as ‘perfect’, ‘awesome’, ‘commendable’, ‘fantastic’, ‘excellent,’ etc, provide a higher level of compliment than other words, such as ‘fine’, ‘suitable’, ‘fair’, ‘average,’ etc. In addition, icons or expressions of emotions such as smiley faces and the like are considered as compliments. In addition, ranking engine 218 weighs the rank of the user-generated content items with an influential power of the social media accounts from which the user-generated content items are collected. For example, owing to more popularity of a platform ‘F’ over a platform ‘G’ among target users of a particular product, ranking engine 218 assigns higher weighs to the user-generated content items obtained from the platform ‘F’ and lower weighs to the user-generated content items obtained from the platform ‘G’.

Further, ranking engine 218 scales the rank of the user-generated content items by the number of defined product offer attributes (212 matching the user-generated content items. For example, if a user generated content item includes attributes ‘a’ and ‘b’, it will be ranked more highly than a user generated content item including just attribute ‘a’.

In yet another embodiment of the present disclosure, ranking engine 218 determines ranking of the user-generated content items in various stages. In a first stage, ranking engine 218 defines attributes of the product to be used as search terms. The attributes of the product may include, but are not limited to a brand name, a company name and a product function. In addition, ranking engine 218 determines the social media accounts that are relevant to the product to that they may be monitored and/or searched. The determination of the relevant social media accounts could be done automatically by reading a pre-defined database through an application programming interface (hereinafter “API”) or manually by receiving input from a software user. Moreover, weighs ‘wᵢ’ are assigned to the social media accounts. For example, the user-generated content from a notorious user of a brand might be more valuable than the user-generated content from a celebrity. In an embodiment of the present disclosure, for each user-generated content item i that includes one of attributes 212, a term (Atᵢ) is defined as number of attributes in the user-generated content item i. In addition, a weight or heuristic value hᵢ is assigned to the user-generated content item i. The heuristic value hᵢ corresponds to words that add more value to the user-generated content item i. For example, words such as ‘great’, ‘fantastic’, ‘perfect’, etc. are more valuable than words such as ‘good’, ‘ok’, ‘fine’, etc. The heuristic value hᵢ corresponding to a word is pre-defined by a software user through experience or common-sense. Further, the ranking Rᵢ is defined as:

Rᵢ=Atᵢwᵢhᵢ

where i=1, 2, 3, . . . n

Following the first stage, in a second stage, ranking engine 218 performs filtering of the user-generated content items with the help of filter 208. The filtering is defined in terms of a heuristic value hᵢ and a threshold value. If the threshold values of the user-generated content items are greater than a pre-defined threshold value set by a software user through experience, then the user-generated content items are considered to be publishable along with the advertisement of the product and/or product offers. Moreover, if the heuristic value hᵢ is defined to be zero for some user-generated content item i then the threshold becomes positive. Further, if the user-generated content item i is generated by a user from a social media account belonging to a group from which a considered brand does not want to associate with, then wᵢ=0, otherwise wᵢ and hᵢ can be assigned any desirable value, according to the process explained above.

In yet another embodiment of the present disclosure, content crawler 216 continuously updates content resources storage device 204 by collecting newly published user-generated content items from social media platform server 114 and removing expired user-generated content items having an unacceptable age or low ranking.

In yet another embodiment of the present disclosure, presentation manager 220 constructs a webpage widget combining the first set of highly ranked user-generated content items with the first product offer.

In yet another embodiment of the present disclosure, scoring engine 222 scores the ranked, user-generated content items for popularity. Moreover, presentation manager 220 works with scoring engine 222 to replace a first product offer with a second product offer when a popularity score of a third set of highly ranked user-generated content items combined with the second product offer exceeds a popularity score of the first set of highly ranked user-generated content items.

In yet another embodiment of the present disclosure, scoring engine 222 counts a number of interactions experienced by the user-generated content items or the product offers combined with the user-generated content items to score the user-generated content items for popularity.

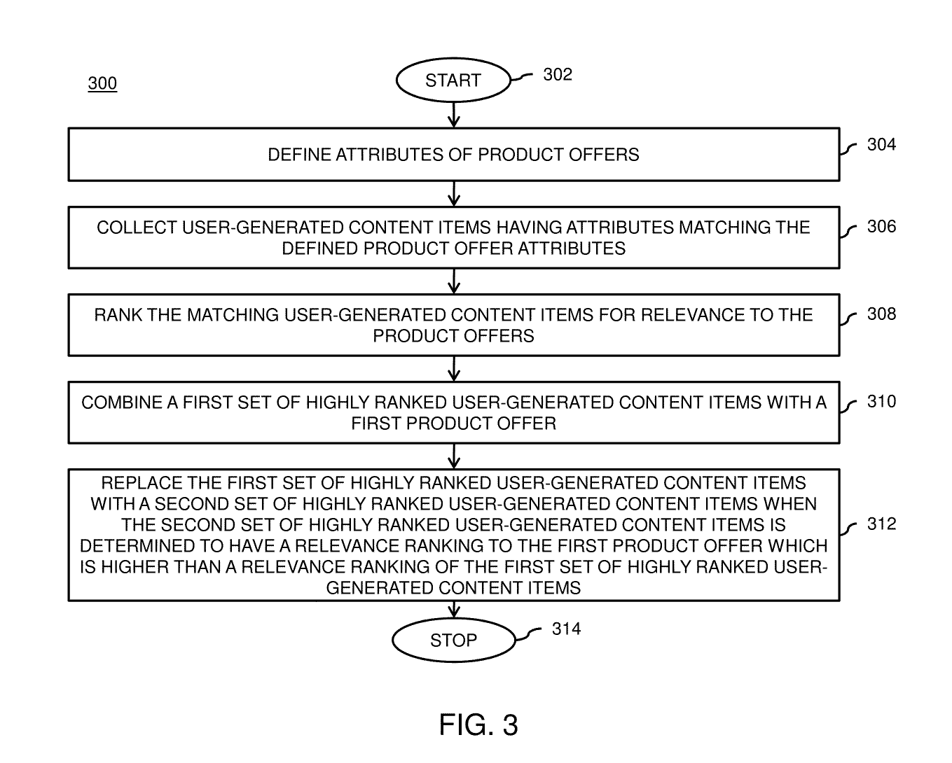

FIG. 3 illustrates a flowchart 300 for increasing an appeal of product offers with user-generated content, in accordance with an embodiment of the present disclosure. The flowchart initiates at a step 302. At a step 304, attributes of the product offers are defined. The attributes of the product offers include, but may not be limited to, a brand name, a company name and functionality of products offered. Following step 304, at a step 306, the user-generated content items having attributes matching with attributes 212 are collected at content resources storage device 204. For example, if a user ‘X’ posts a comment on his/her social media account and the comment contains some attributes of the product defined in step 304, then the comment is stored at content resources storage device 204. Following step 306, at a step 308, the matching user-generated content items are ranked for relevance to the product offers. That is, if the source of the comment is a notorious user of a given product, then the comment is considered to be relevant to the product. Following step 308, at a step 310, the first set of highly ranked user-generated content items is combined with the first product offer. Following step 310, at a step 312, the first set of highly ranked user-generated content items is replaced with the second set of highly ranked user-generated content items when the second set of highly ranked user-generated content items is determined to have higher relevance ranking to the first product offer than the relevance ranking of the first set of highly ranked user-generated content items. The flowchart 300 terminates at a step 314.

Optionally, the method includes defining the threshold of publishability for the product offers. In addition, the method optionally includes publishing the combined first set of highly ranked user-generated content items and the first product offer when the ranking of the first set of highly ranked user-generated content items exceeds the threshold of publishability for the first product offer. Further, the method optionally includes forgoing publication of the combined first set of highly ranked user-generated content items and the first product offer when the threshold of publishability for the first product offer exceeds the ranking of the first set of highly ranked user-generated content items.

Moreover, optionally, the method includes continuously updating content resources storage device 204 by collecting newly published user-generated content items from the social media accounts and/or social media websites and removing user-generated content items which have expired due to unacceptable age or low ranking.

Moreover, optionally, the method includes constructing a webpage widget by combining the first set of highly ranked user-generated content items with the first product offer.

Moreover, optionally, the method includes scoring the ranked user-generated content items for popularity and replacing the first product offer with the second product offer when the popularity score of a third set of highly ranked user-generated content items which is combined with the second product offer exceeds the popularity score of the first set of highly ranked user-generated content items.

Moreover, optionally, the method includes counting a number of interactions experienced by the combined product offers and user-generated content items while scoring the user-generated content items for popularity.

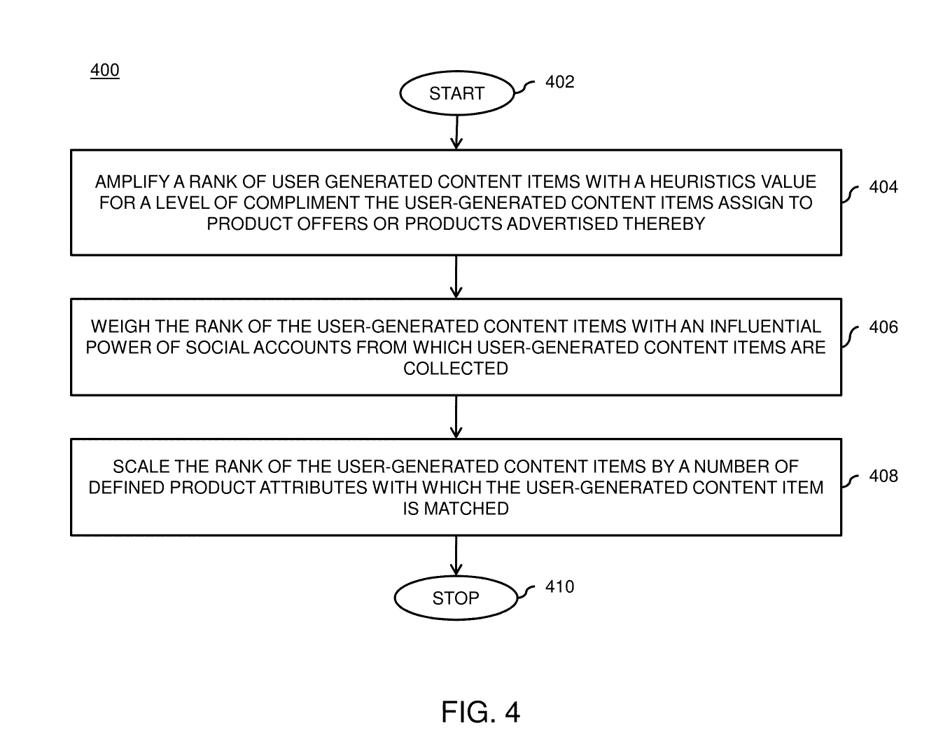

FIG. 4 illustrates a flowchart 400 for ranking user-generated content items, in accordance with an embodiment of the present disclosure. The flowchart initiates at a step 402. At a step 404, the rank of the user-generated content items is amplified with a heuristic value according to a level of compliment the user-generated content items assign to the product offers or the products advertised. For example, if a comment posted on a social account contains some positive terms for the product offer, then according to a level of positivity of the positive terms, a heuristic value is assigned to the comment. Following step 404, at a step 406, the rank of the user-generated content items is weighed according to the influential power of the social media accounts from which the user-generated content items are collected. In accordance with step 406, the rank of a comment ‘P’ is manipulated according to a popularity of the social media account through which the comment ‘P’ is posted. Following step 406, at a step 408, the rank of a user-generated content item is scaled by a number of defined product attributes/attributes 212 matching with the user-generated content item. The flowchart 400 terminates at a step 410.

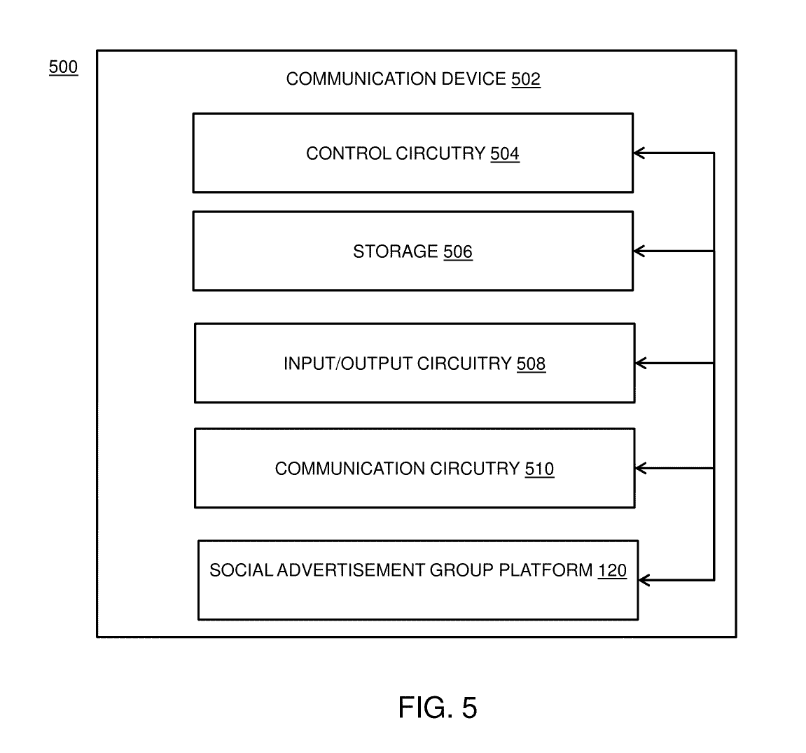

In an embodiment of the present disclosure, social advertisement group platform 120 is present on communication device 118. Each of communication devices 104, 110, 118, 124 has functional components similar to the functional components of a communication device 502 shown in FIG. 5.

The communication device 502 may include, but is not limited to, a control circuitry 504, a storage 506, an Input/Output (I/O) circuitry 508, and a communication circuitry 510.

From the perspective of the present disclosure, control circuitry 504 includes any processing circuitry or processor operative to control operations and performance of the communication device 502. For example, control circuitry 504 may be used to run operating system applications, firmware applications, media playback applications, media editing applications, or any other application. In an embodiment, control circuitry 504 drives a display and processes inputs received from a user interface.

From the perspective of the present disclosure, storage 506 includes one or more storage mediums including a hard-drive, a solid state drive, a flash memory, a permanent memory, such as Read-Only Memory (ROM), any other suitable type of a storage component, or any combination thereof. Storage 506 may store, for example, media data (e.g., music and video files), and application data (e.g., for implementing functions on communication device 502).

From the perspective of the present disclosure, I/O circuitry 508 may be operative to convert, analog signals and other signals into digital data as well as encode and/or decode the analog signals, if necessary. In an embodiment, I/O circuitry 508 may also convert digital data into any other type of signal, and vice-versa. For example, I/O circuitry 508 may receive and convert physical contact inputs (e.g., from a multi-touch screen), physical movements (e.g., from a mouse or a sensor), analog audio signals (e.g., from a microphone), or any other input. The digital data may be provided to and/or received from control circuitry 504, storage 506, or any other component of communication device 502.

It may be noted that I/O circuitry 508 is illustrated in FIG. 5 as a single component of communication device 502. However, those skilled in the art would appreciate that several instances of I/O circuitry 508 may be included in communication device 502.

Communication device 502 may include any suitable interface or component for allowing a user to provide inputs to I/O circuitry 508. Communication device 502 may include any suitable input mechanism. Examples of the input mechanism include, but may not be limited to, a button, a keypad, a dial, a click wheel, and a touch screen. In an embodiment, communication device 502 may include a capacitive sensing mechanism, or a multi-touch capacitive sensing mechanism.

In an embodiment, communication device 502 may include specialized output circuitry associated with output devices such as, for example, one or more audio outputs. The audio outputs may include one or more speakers built into communication device 502, or an audio component that may be remotely coupled to communication device 502.

The one or more speakers can be mono speakers, stereo speakers, or a combination of both. The audio components can include a headset, a headphone or ear buds that may be coupled to communication device 502 with a wire or wirelessly.

In an embodiment, I/O circuitry 508 may include a display circuitry for providing a display visible to the user. For example, the display circuitry may include a screen (e.g., an LCD screen) that is incorporated in communication device 502. The display circuitry may include a portable display or a projecting system for providing a display of content on a surface remote from communication device 502 (e.g., a video projector). In an embodiment, the display circuitry may include a coder/decoder to convert digital media data into analog signals. For example, the display circuitry may include video codecs, audio codecs, or any other suitable type of codec.

The display circuitry may include display driver circuitry, circuitry for driving display drivers, or both. The display circuitry may be operative to display content. The display content can include media playback information, application screens for applications implemented on communication device 502, information regarding ongoing communications operations, information regarding incoming communications requests, or device operation screens under the direction of control circuitry 504. Alternatively, the display circuitry may be operative to provide instructions to a remote display.

From the prospective of the present disclosure, communications circuitry 510 may include any suitable communications circuitry operative to connect to a communications network and to transmit communications (e.g., voice or data) from communication device 502 to other devices within the communications network. Communications circuitry 510 may be operative to interface with the communications network using any suitable communications protocol. Examples of the communications protocol include, but may not be limited to, Wi-Fi, Bluetooth (Bluetooth is a registered trademark), radio frequency systems, infrared, LTE (Long-Term Evolution), GSM (Global System for Mobile communications), GSM plus EDGE (Enhanced Data rates for GSM Evolution), CDMA (Code Division Multiple Access), and quad-band.

In an embodiment, a same instance of communications circuitry 510 may be operative to provide for communications over several communications networks. In an embodiment, communication device 502 may be coupled with a host device for data transfers, synching communication device 502, software or firmware updates, providing performance information to a remote source (e.g., providing riding characteristics to a remote server) or performing any other suitable operation that may require communication device 502 to be coupled to a host device. Several computing devices may be coupled to a single host device using the host device as a server. Alternatively or additionally, communication device 502 may be coupled to several host devices (e.g., for each of the plurality of the host devices to serve as a backup for data stored in communication device 502)).

Methods and systems of present disclosure have many advantages over the prior art. Dynamic adapting of advertisements of a product to social media objects is enabled. In addition, disclosed methods and systems enable association of the social media objects to the advertisements of the product by inserting the social media objects along with the advertisements of the product. Moreover, advertisements of the product are dynamically updated by continuously analyzing the social media objects and replacing irrelevant social media objects with relevant and highly preferred social media objects. Further, t dynamic filtering of the social media objects allows for determining the most relevant and highly preferred social media objects. Disclosed approaches generate maximum clicks on a webpage with the advertisements and thereby increase probability of sales of the product advertised.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A computer-implemented method for increasing an appeal of product offers with user-generated content items, comprising:
defining attributes of the product offers;
collecting, at a content resources storage device, the user-generated content items having attributes matching the defined product offer attributes;
ranking the matching user-generated content items for relevance to the product offers;
combining a first set of highly ranked user-generated content items with a first product offer; and
replacing the first set of highly ranked user-generated content items with a second set of highly ranked user-generated content items when the second set of highly ranked user-generated content items is determined to have a relevance ranking to the first product offer which is higher than a relevance ranking of the first set of highly ranked user-generated content items.

2. The computer-implemented method as set forth in claim 1, wherein ranking the user-generated content items further comprises one or more of:
amplifying the rank of the user generated content items with a heuristics value for a level of compliment the user-generated content items assign to the product offers or products advertised thereby;
weighing the rank of the user-generated content items with an influential power of social accounts from which the user-generated content items are collected; and
scaling the rank of the user-generated content items by a number of the defined product offer attributes with which the user-generated content item is matched.

3. The computer-implemented method as set forth in claim 1, further comprising:
defining a threshold of publishability for the product offers;
publishing the combined first set of highly ranked user-generated content items and first product offer when a ranking of the first set of highly ranked user-generated content items exceeds the threshold of publishability for the first product offer; and
forgoing publication of the combined first set of highly ranked user-generated content items and first product offer when the threshold of publishability for the first product offer exceeds the ranking of the first set of highly ranked user-generated content items.

4. The computer-implemented method as set forth in claim 1, further comprising continuously updating the content resources storage device by collecting newly published user-generated content items from social media websites and removing user-generated content items which have expired due to unacceptable age or low ranking.

5. The computer-implemented method as set forth in claim 1, wherein combining the first set of highly ranked user-generated content items with the first product offer further comprises constructing a webpage widget from the first set of highly ranked user-generated content items.

6. The computer-implemented method as set forth in claim 1, further comprising:
scoring the ranked user-generated content items for popularity; and
replacing the first product offer with a second product offer when a popularity score of a third set of highly ranked user-generated content items combined with the second product offer exceeds a popularity score of the first set of highly ranked user-generated content items.

7. The computer-implemented method as set forth in claim 6, wherein scoring the user-generated content items for popularity further comprises counting a number of interactions experienced by the product offers combined therewith.

8. A computer program product to increase an appeal of product offers with user-generated content items, the computer program product residing on a non-transitory computer readable storage medium and comprising instructions that, when executed by a processor, cause one or more computers to:
define attributes of the product offers;
collect, at a content resources storage device, the user-generated content items having attributes matching the defined product offer attributes;
rank the matching user-generated content items for relevance to the product offers;
combine a first set of highly ranked user-generated content items with a first product offer; and
replace the first set of highly ranked user-generated content items with a second set of highly ranked user-generated content items when the second set of highly ranked user-generated content items is determined to have a relevance ranking to the first product offer which is higher than a relevance ranking of the first set of highly ranked user-generated content items.

9. The computer program product as set forth in claim 8, wherein the instructions causing the one or more computers to rank the user-generated content items further cause the one or more computers to:
amplify the rank of the user generated content items with a heuristics value for a level of compliment the user-generated content items assign to the product offers or products advertised thereby;
weigh the rank of the user-generated content items with an influential power of social accounts from which the user-generated content items are collected; and
scale the rank of the user-generated content items by a number of the defined product offer attributes with which the user-generated content item is matched.

10. The computer program product as set forth in claim 8, further comprising instructions that, when executed by the processor, cause the one or more computers to:
define a threshold of publishability for the product offers;
publish the combined first set of highly ranked user-generated content items and first product offer when a ranking of the first set of highly ranked user-generated content items exceeds the threshold of publishability for the first product offer; and
forgo publication of the combined first set of highly ranked user-generated content items and first product offer when the threshold of publishability for the first product offer exceeds the ranking of the first set of highly ranked user-generated content items.

11. The computer program product as set forth in claim 8, further comprising instructions that, when executed by the processor, cause the one or more computers to continuously update the content resources storage device by collecting newly published user-generated content items from the social media websites and removing user-generated content items which have expired due to unacceptable age or low ranking.

12. The computer program product as set forth in claim 8, wherein the instructions that cause the one or more computers to combine the first set of highly ranked user-generated content items with the first product offer further cause the one or more computers to construct a webpage widget from the first set of highly ranked user-generated content items.

13. The computer program product as set forth in claim 8, further comprising instructions that, when executed by the processor, cause the one or more computers to:
score the ranked user-generated content items for popularity; and
replace the first product offer with a second product offer when a popularity score of a third set of highly ranked user-generated content items combined with the second product offer exceeds a popularity score of the first set of highly ranked user-generated content items.

14. The computer program product as set forth in claim 13, wherein the instructions that cause the one or more computers to score the ranked user-generated content items for popularity further cause the one or more computers to count a number of interactions experienced by the product offers combined therewith.

15. A system for increasing an appeal of product offers with user-generated content items, comprising:
a memory;
a content resources storage device;
a library, stored in the memory, defining attributes of the product offers as well as a plurality of utilities that comprise:
a content-crawler;
a ranking engine; and
a presentation manager;
wherein the content-crawler is arranged to collect, at the content resources storage device, user-generated content items having attributes matching the attributes of the product offers as defined by the library; and
wherein the ranking engine is configured to rank the matching user-generated content items for relevance to the product offers;
wherein the presentation manager is arranged to combine a first highly ranked user-generated content item with a first product offer and replace the first highly ranked user-generated content item with a second highly ranked user-generated content item when the second highly ranked user-generated content item is determined to have a relevance ranking to the first product offer which is higher than a relevance ranking of the first highly ranked user-generated content item; and
a processor configured to activate the utilities.

16. The system as set forth in claim 15, wherein the ranking engine is further configured to perform one or more of:
amplify the rank of the user generated content items with a heuristics value for a level of compliment the user-generated content items assign to the product offers or products advertised thereby;
weigh the rank of the user-generated content items with an influential power of social accounts from which the user-generated content items are collected; and
scale the rank of the user-generated content items by a number of the defined product offer attributes with which the user-generated content item is matched.

17. The system as set forth in claim 15, further comprising a filter defining a threshold of publishability for the product offers; and
wherein the presentation manager is further arranged to:
publish the combined first set of highly ranked user-generated content items and first product offer when a ranking of the first set of highly ranked user-generated content items exceeds the threshold of publishability for the first product offer; and
forgo publication of the combined first set of highly ranked user-generated content items and first product offer when the threshold of publishability for the first product offer exceeds the ranking of the first set of highly ranked user-generated content items.

18. The system as set forth in claim 15, wherein the content crawler is further arranged to continuously update the content resources storage device by collecting newly published user-generated content items from social media websites and removing user-generated content items which have expired due to unacceptable age or low ranking.

19. The system as set forth in claim 15, wherein the presentation manager is further arranged to construct a webpage widget from the first set of highly ranked user-generated content items in order to combine the first set of highly ranked user-generated content items with the first product offer.

20. The system as set forth in claim 15, wherein the plurality of utilities further comprise a scoring engine configured to score the ranked user-generated content items for popularity; and
wherein the presentation manager is further configured to replace the first product offer with a second product offer when a popularity score of a third set of highly ranked user-generated content items combined with the second product offer exceeds a popularity score of the first set of highly ranked user-generated content items.

21. The system as set forth in claim 20, wherein the scoring engine is further configured to count a number of interactions experienced by the user-generated content items or the product offers combined therewith in order to score the user-generated content items for popularity.
